(19) United States
(12) Patent Application Publication
(10) Pub. No.: US 2009/0278703 A1
(43) Pub. Date: Nov. 12, 2009

(54) MULTIPLE DOOR

(76) Inventor: Miguel Angel Iglesias Ballester, Barcelona (ES)

Correspondence Address: OSTROLENK FABER GERB & SOFFEN, 1180 AVENUE OF THE AMERICAS, NEW YORK, NY, 100368403, US

(21) Appl. No.: 12/305,261

(22) PCT Filed: Jun. 22, 2006
(86) PCT No.: PCT/ES2006/000366

§ 371 Date: Dec. 17, 2008

(51) Int. Cl. G06F 13/42; E06B 9/44

(52) U.S. Cl. 340/825; 160/241

(57) ABSTRACT

This door comprises a structure with pillars and/or longitudinal members, two or more parallel drums for winding up respective closure elements, and guides for the parallel, guided displacement of said closure elements. The openings of the guides are arranged in a stepped fashion for the insertion of the closure elements in a consecutive position in accordance with the sequence of arrangement of the respective drums.

### OBJECT OF THE INVENTION

The invention refers to a multiple door which has a security closure element and at least one closure element such as a fast closing door with one or more curtains.

### BACKGROUND TO THE INVENTION

In industrial units, warehouses and similar places it is common to have a fast closing door installed that allows people, fork lift trucks and vehicles to pass during the day in a more or less controlled manner, this door being open for the minimum time necessary, thus minimising the draughts, and enhancing thermal and acoustic insulation of the inside in respect to the outside.

These doors have at least one revolving drum on an axle, which is assembled together with the activating motor onto a structure that is assembled just behind the threshold of the facade. This structure has some guides on both side pillars, or directly on the doorjambs of the threshold for the movement of some cross members connected to the curtain or canvas that goes up and down from the stated upper drum. These doors are not secure to make a closure at the end of the activity, for example at night. Therefore they are usually added to with some external closure doors, made by preference from slats or metal pieces with greater rigidity and strength. Many times these doors or closure elements are vertical, with a winding drum whose axle is connected to its corresponding activation motor. The external closure element can be integrated into the threshold of the facade or equally fitted into a support structure with vertical pillars that fix the guides along which the slats of the closure element run.

With this construction of two consecutive doors after the threshold of the facade a large amount of space is lost and the installation costs are increased on duplicating the support structures.

### DESCRIPTION OF THE INVENTION

The multiple door of this invention has a series of special technical features aimed at allowing the installation of several closure elements or slats which can be wound up at the threshold entrance in an effective manner, with great space saving and improvements in the maintenance tasks.

In effect the door has two or more drums for winding up of two or more closure elements made from rigid slats or flexible sheets, these drums being arranged aligned in parallel onto the side of a single support structure. The guides of each one of the wound up slat or sheet closure elements are arranged on the inner facing sides of the structure for their parallel displacement. Said closure elements are introduced into the openings adjacent to their corresponding guides in a consecutive position compared to the arrangement sequence of the drums, in order to do this the openings of the guides are in a stepped fashion in regard to the arrangement of the corresponding drums. In this way a single structure or doorway holds several closure elements, the drums and the machinery being completely accessible for maintenance.

In order to achieve a reduction in the materials used, the guides for the closure elements are integrated in a single profile that is easily housed in the structure. It has also been provisioned that the guides and the adjacent pillar or longitudinal member are made from the same self supporting profile.

In the event of it being required for the closure elements to have horizontal displacement, the drums are arranged on some vertical axles, on one side of the threshold or doorway.

The various wind up closure elements can be controlled from a control panel connected to some sensors that can regulate the synchronised or independent workings of each one of them, according to how it is considered necessary.

### DESCRIPTION OF THE FIGURES

In order to complete the description that is being made and for the purpose of providing a better understanding of its characteristics, a set of drawings is attached to this description in which the figures being by way of illustration and are not by way of limitation on the invention, in which the following is shown:

FIG. 1. A raised view of the threshold of the facade with the multiple door installed.

FIG. 2. A rear view of FIG. 1.

FIG. 3. A profile view of the door showing the activation motors.

FIG. 4. A view of a sectioned profile.

FIG. 5. A rear view of a multiple door assembly with horizontal displacement.

FIG. 6. A cross section detail of a pillar and the individual guides.

FIG. 7. A cross section view of the guides made from a single profile housed in the pillar.

FIG. 8. A cross section view of the guides made in the profile of the pillar itself.

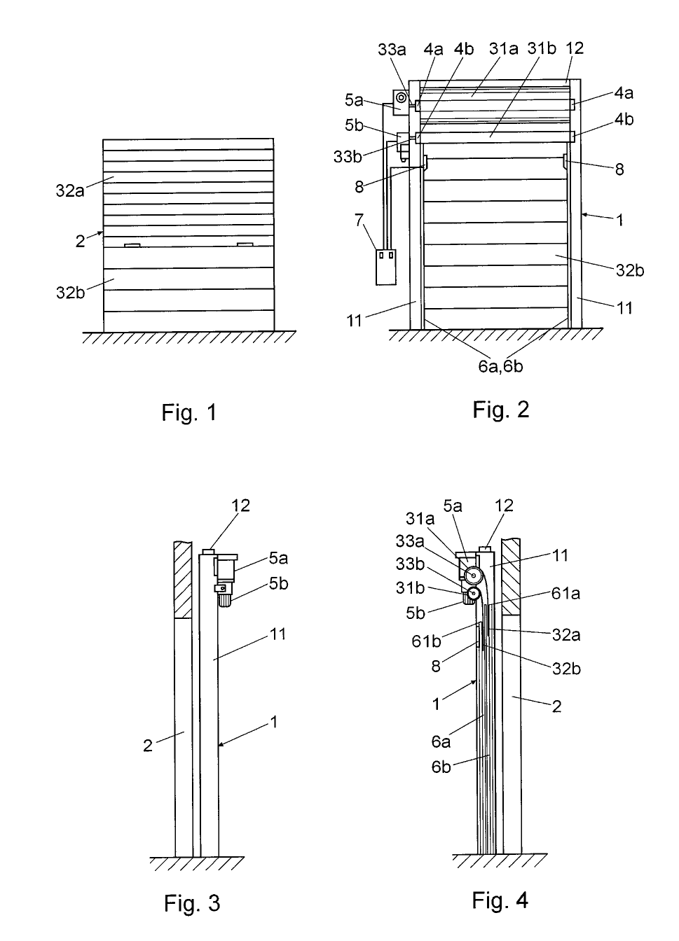

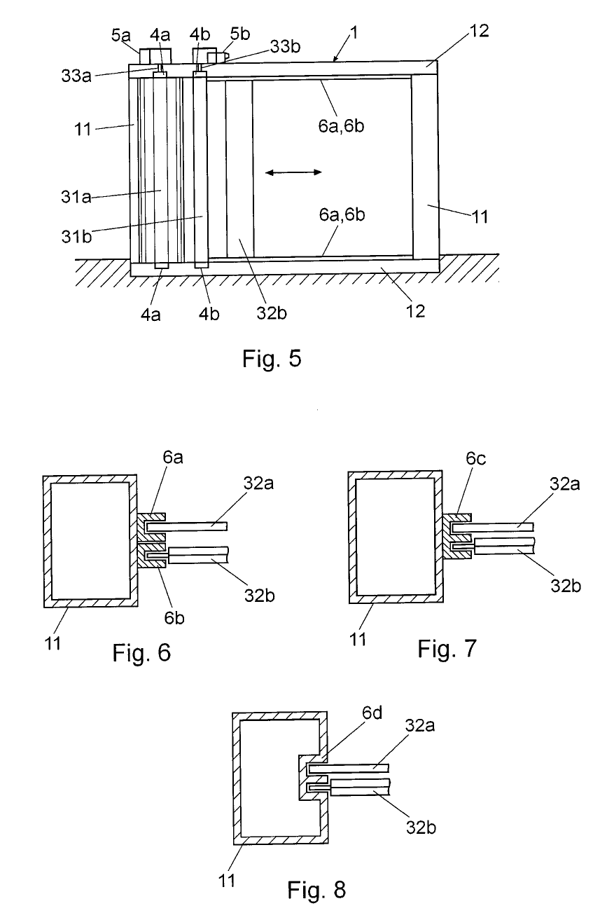

### PREFERRED EMBODIMENT OF THE INVENTION

As can be seen in the referred to figures the multiple door is made up of a support structure (1) made up of two pillars (11) and longitudinal members (12) placed next to the inner part of an access threshold (2) of a facade or something similar.

Two transversally arranged drums (31a and 31b) are fitted in the upper part of the structure (1) for winding up a closure element (32a), made from rigid security sheets, by preference metal, and a fast opening and closing canvas closure element (32b). The structure (1) has some guides (6a and 6b) next to the pillars (11) for the parallel displacement of the doors (32a and 32b) . The axles (33a and 33b) of these drums (31a and 31b) are aligned in parallel and anchored by some supports (4a and 4b) to the structure (1). Each axle (33a and 33b) is connected to its own activation motor (5a and 5b), while both drums (31a and 31b) are hidden by the lintel or upper part of the threshold (1).

The openings (61a and 61b) in the guides (6a and 6b) are arranged in a stepped fashion for the insertion of the closure elements (32a and 32b) in a consecutive position in accordance with the sequence of arrangement of the drums (31a and 31b) on the structure (1).

In an alternative embodiment shown in FIG. 7, the guides (6a and 6b) are made from a single profile (6c) housed into the pillar (11) of the structure. In turn, in an alternative shown in FIG. 8, the guides (6d) and the pillar (11) are arranged in a single integral profile.

The motors (5a and 5b) of the two closure elements (32a and 32b) are connected to a control panel (7) for the synchronised or independent activation as required. This control panel (7) is also connected to some movement sensors (8) on the closure elements (32a and 32b) for automatic working.

Once having sufficiently described the nature of the invention, likewise having given a preferred embodiment it is placed on record that the materials, shape, size and arrangement of the elements described can be modified provided that they do not mean an alteration of the basic essentials of the invention that are claimed below.

1. Multiple door, of the type that has at least a structure with pillars and/or longitudinal members that can be housed in the rear of the access threshold of a facade or similar door, the structure supporting a wind up closure element on a drum, this drum being held by supports on the axle, which is connected to an activation motor, the closure element being arranged so that it can slide along pairs of longitudinal guides, preferably vertical or horizontal, wherein it has two or more wind up drums with two or more closure elements, these drums being aligned in parallel onto a side member of a single structures, behind the lintel of the threshold, these guides of each one of the closure elements made from rigid slats or wind up sheets being arranged on the inner face of the structure for the displacement in parallel with said closure elements, and the openings of the guides are arranged in a stepped fashion for the insertion of the closure elements in a consecutive position in accordance with the sequence of arrangement of the respective drums.

2. A door, according to claim 1, wherein the guides of the two closure elements are fitted into a single profile for the independent movement of the closure elements.

3. A door, according to claim 1, wherein the guides are fitted into a single profile together with the adjacent pillar or longitudinal member of the structure.

4. A door, according to claim 1, wherein the drums are arranged on a vertical axis to one side of the threshold for the horizontal displacement of the closure elements.

5. A door, according to claim 1, wherein it has a control panel connected to some sensors which control the synchronised or independent working of the motors of the closure elements.
